(19) United States
(12) Patent Application Publication
(10) Pub. No.: US 2026/0135896 A1
(43) Pub. Date: May 14, 2026

(54) SYSTEMS AND METHODS FOR PROACTIVE ARTIFICIAL INTELLIGENCE

(71) Applicant: PANASONIC WELL LLC, Palo Alto, CA (US)

(72) Inventors: Yoky Matsuoka, Los Altos Hills, CA (US); David Justus, Brooklyn, NY (US); Sandy Anuras, Seattle, WA (US); Prerna Kaul, Palo Alto, CA (US); Katlyn Bren Johnson, Palo Alto, CA (US); Mary Christine Virginia Baynham Pitts, Palo Alto, CA (US); Peter Markatos, Palo Alto, CA (US); Greg Johnson, Palo Alto, CA (US); Anisha Kharkia, Palo Alto, CA (US); Sanjay Yadqirkar, Palo Alto, CA (US); Dipti Rai, Pleasanton, CA (US)

(21) Appl. No.: 19/339,452

(22) Filed: Sep. 25, 2025

Related U.S. Application Data
(60) Provisional application No. 63/720,567, filed on Nov. 14, 2024.

(51) Int. Cl. H04L 65/65; G06F 3/01; G06F 16/335

(52) U.S. Cl. CPC H04L 65/65; G06F 3/011; G06F 16/337

(57) ABSTRACT

An AI Agent Platform autonomously processes data streams for event implementation. The AI Agent Platform receives a real-time data stream associated with a profile. The AI Agent Platform defines a dataset from the data stream by dynamically sampling the data stream according to a time window selected using the profile. The AI Agent Platform may detect a correspondence between the dataset and an event registry. The event registry may include proactive events having a predicted significance for a user. The AI Agent Platform may then execute a machine-learning model using an event, the dataset, and the profile to define an implementation of the event for the user. Upon receiving authorization to execute the event, the AI Agent Platform facilitates execution of the implementation of the event.

### CROSS-REFERENCE TO RELATED APPLICATIONS

The present application claims the benefit of U.S. Provisional Application 63/720,567 filed Nov. 14, 2024 and is related to U.S. Non-Provisional Application entitled “SYSTEMS AND METHODS FOR DYNAMIC CONVERSATIONAL INTERFACES ACCORDING TO DETECTED USER BEHAVIORS” filed Sep. 25, 2025 (Attorney Docket No.: 109304-847284-009300US), U.S. Non-Provisional Application entitled “MACHINE-LEARNING TECHNIQUES FOR FAMILY PROFILE MANAGEMENT” filed Sep. 25, 2025 (Attorney Docket No.: 109304-847282-009400US), U.S. Non-Provisional Application entitled “SYSTEMS AND METHODS FOR AUTOMATED USER RELATIONSHIP PROFILING” filed Sep. 25, 2025 (Attorney Docket No.: 109304-847283-009500US) and U.S. Non-Provisional Application entitled “AI AGENT PLATFORMS” filed Sep. 25, 2025 (Attorney Docket No.: 109304-855123-009600US), each of which are incorporated herein by reference in their entireties and for all purposes.

### TECHNICAL FIELD

This disclosure relates generally to artificial intelligence platforms, and more particularly to proactive operations of artificial intelligence frameworks operating on real-time data.

### BACKGROUND

Artificial intelligence systems operate on inputs to provide particular outputs and/or services to users. The quality of the output from an artificial intelligence system is directly related to the quality of the input, the quality of the training data, and the quality of the training process of the artificial intelligence system. The quality of the training data can be managed through selection of datasets from historical data sources and/or previous operations of the artificial intelligence systems. The quality of the training process can be managed through various hyperparameters, accuracy metrics, and training methodologies (e.g., supervised learning, unsupervised learning, etc.). The quality of some inputs to the artificial intelligence systems can be controlled through various preprocessing operations, such as dimensionality reduction, interpolation/extrapolation techniques, filtering, etc. However, such systems may be unable to manage the quality of input data dependent on a user or received from the user.

### SUMMARY

Methods are described herein for an AI Agent Platform configured to process disparate data streams. Some methods may include: receiving one or more real-time data streams associated with a profile, wherein the profile corresponds to one or more related users, and wherein the one or more real-time data streams are received from disparate sources; defining a dataset from the one or more real-time data streams by dynamic sampling of the real-time data stream according to a time window selected based on the profile; detecting, based on the dataset, a correspondence between a portion of the dataset and an event of an event registry, wherein the event registry includes an identification of proactive events with a predicted significance for a user of the one or more related users; executing, in response to detecting the correspondence between the portion of the dataset and the event of the event registry, a machine-learning model using an identification of the event, the dataset, and the profile, wherein the machine-learning model defines an implementation of the event for the user; receiving authorization to execute the event; and facilitating execution of the implementation of the event on behalf of the user, wherein facilitating.

Some methods described herein may also include: receiving communications from a communication session between a user and an automated communication service, wherein the automated communication service is configured to converse with the user using natural language communications, and wherein the automated communication service invokes a machine-learning model to generate an implementation of task for execution on behalf of the user; executing the machine-learning model using the communications, wherein the machine-learning model generates a probability that the machine-learning model is configured to generate an implementation of a task identified in a communication of the communications; determining that the probability is less than a threshold; and connecting a terminal device to the communication session, wherein the terminal device is operated by agent configured to process the communication in place of the automated communication service.

The systems are described herein for an AI Agent Platform configured to process disparate data streams. The systems may include one or more processors and a non-transitory computer-readable medium storing instructions that, when executed by the one or more processors, cause the one or more processors to perform any of the methods as previously described.

The non-transitory computer-readable media described herein may be configured to store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example AI Agent Platform that provides natural language communication processing for task facilitation according to aspects of the present disclosure.

FIG. 2 illustrates a block diagram of components an AI Agent Platform according to aspects of the present disclosure.

FIG. 3 illustrates a flowchart of an example process for autonomous operations of machine-learning operations that generate events for users according to aspects of the present disclosure.

FIG. 4 illustrates a flowchart of an example process for implementing fault tolerant communications within agent platforms according to aspects of the present disclosure.

FIG. 5 illustrates an example computing device architecture of an example computing device that can implement the various techniques described herein according to aspects of the present disclosure.

### DETAILED DESCRIPTION

Systems and methods are described herein for Artificial-Intelligence Agent Platform (AI Agent Platform) including a hybrid communication network for processing disparate data streams of real-time data and non-real-time data. Many software and AI systems either operate autonomously or based on user direction such as a user providing express directions or executing instructions, etc. Conventional software and AI systems that operate autonomously are limited by the data sources received as input and the algorithms/training of the software and AI systems. If algorithms/training of the software and AI systems is incomplete or faulty then the resulting outputs of the software and AI systems will be incomplete or faulty. Similarly, if the input data is incomplete or is faulty, then the outputs of the software and AI systems will be incomplete and/or include faulty (e.g., inaccurate, etc.). In addition, the integrity of the software and AI systems will degrade further over time (e.g., with feedback further integrating the incomplete and/or faulty inputs or outputs, etc.). Similarly, conventional software and AI systems dependent on users for execution or data management may fail to execute consistently (e.g., due to lack of user input or scheduling issues) or execute too frequently impacting processing resources of the system), generate inconsistent outputs (e.g., inconsistent accuracy of outputs, outputs that may not be usable to the user, outputs that are generated too early or too late based on real-time data, etc.), generate poor feedback that impacts the integrity of AI systems (e.g., impacting future training iterations, impacting future models, etc.).

The methods and systems described herein include AI Agent Platform including a hybrid communication network. The hybrid communication network of the AI Agent Platform operates autonomously to proactively identify and execute tasks for users from real-time and non-real-time data streams. The hybrid communication network may establish communication sessions (e.g., live bi-directional communications between a user and an automated communication service, a user and a terminal device, etc.) for communicating with users, executing tasks for users, resolving queries, etc. The hybrid communication network includes a fault tolerant process that provides alternative processing to prevent processing stalls, processing delays, resolve load-balancing, etc. and to prevent processing faults from impacting the integrity AI systems of the AI Agent Platform.

The AI Agent Platform may detect instances where tasks cannot be executed (e.g., such as particular tasks, particular task types, task complexity, etc.), the AI Agent Platform lacks the capability or processing resources to execute a task, AI Agent Platform detects a processing delay, etc. When the AI Agent Platform detects a processing fault, the AI Agent Platform automatically connects a terminal device to the communication session and the terminal device may resolve the processing fault. By seamlessly connecting additional communication sources, the AI Agent Platform can continue operations with delaying processing of tasks for users while maintaining the integrity of the AI Agent Platform.

The hybrid communication network provides access to artificial-intelligence services through natural-language communications via automated communication services and terminal devices (e.g., operated by admin users, etc.). The AI Agent Platform may receive information associated with a set of related users including real-time and non-real-time data streams (e.g., such as, but are not limited to, Internet-of-Things (IoT) devices, wearable devices, calendars, user profiles, webpages, mobile devices, etc.). The AI Agent Platform uses one or more machine-learning models to process the real-time and non-real-time data streams defining a family profile corresponding to the set of related users. For instance, the set of related users may be related by based on being part of a same family, household, job, team, hobby, association, friends, etc. Alternatively, or additionally, the AI Agent Platform defines the family profile using communications between the set of automated users and automated communication services and/or terminal devices. The AI Agent Platforms provides services to the set of related users using natural language communications. For example, the AI Agent Platform may communicate with the set of related users, identify events and/or tasks for users, define implementations of events or tasks, etc.

The set of related users may be users associated according to one or more characteristics such as being related by family, demographic information, employment information, interests, etc. The AI Agent Platform monitors data streams associated with the set of related users to define the family profile. The AI Agent Platform continuously updates the family profile based on the received data streams and the communications between a user of the related users and the AI Agent Platform (e.g., automated communication services, terminal devices, admin users, etc.).

In some implementations, the AI Agent Platform defines an event registry associated with the set of related users based on information associated with the set of users (e.g., from the family profile, communications with the set of users, the real-time and/or non-real-time data streams, etc.). The event registry may include one or more events with each event including one or more conditions. The one or more events include events that the AI Agent Platform predicts are of interest a user of the set of users (e.g., such as an experience, etc.). The AI Agent Platform continues to monitor the real-time and non-real-time data streams and when a condition associated with an event is satisfied, defines an implementation of the event for the user. For example, the AI Agent Platform may monitor a real-time sports schedule and calendar of a user, determine that a sports team is playing locally on a day that a user is free, and acquire tickets to the game for the user. The AI Agent Platform autonomously identify events, identify an opportunity to implement an event at a future time, and define an implementation of the event without direction from users of the set of related users or from terminal devices. In some examples, a user of the set of related users and/or a terminal device may guide some aspects of the AI Agent Platform such as the generation of the event registry, defining new events and/or conditions, etc. For instance, the AI Agent Platform may proactively identify an event and define an implementation of the event. The AI Agent Platform may then present the implementation of the event to the user for authorization.

In some implementations, the AI Agent Platform may communicate with the set of users using an automated communication service (e.g., a bot) and/or one or more terminal devices (e.g., forming a hybrid communication network). The AI Agent Platform may be configured to execute tasks and provide other services to the set of related users. The automated communication service may parse the natural language communications into an input for one or more machine-learning models of the AI Agent Platform. The AI Agent Platform may include information from the family profile with the input to the one or more machine-learning models to bias the output of the one or more machine-learning models towards an output tailored for the set of related users.

In some instances, the one or more machine-learning models may be limited in the types of tasks that can be executed or may be limited in the complexity of tasks that can be executed. In those instances, the AI Agent Platform may use recursive tasking to execute task. Recursive tasking may process tasks by identifying that an input task cannot be processed by the one or more machine-learning models and iteratively transforming the input task rather than executing the task. The one or more tasks recursively identify one or more tasks that when executed implement the some or all of the input task. For example, the input task may be to plan a birthday party of a user of the set of related users. The one or more machine-learning models may not be able to execute the task directly. Instead, the one or more machine-learning models may define a set of tasks that should be executed to implement the task input (e.g., select a location, acquire a birthday cake, etc.). The one or more machine-learning models may then determine if the set of tasks can be executed and if, so execute each task. If the one or more machine-learning models cannot execute a task, then the automated communication service transmits a communication to a terminal device operated by an admin user. The admin user may then execute individual tasks of the set of tasks or the input task. For example, a task that can only be executed by a human user, etc.) may routed to a terminal device. The one or more machine-learning models and/or the automated communication service may classify tasks and/or the generated set of tasks based on an ability of the one or more machine-learning models (and/or a service of the AI Agent Platform) to execute the task.

In an illustrative example, an AI Agent Platform may receive one or more real-time data streams associated with a family profile. The family profile may correspond to one or more related users. The one or more real-time data streams may be received from varying (i.e., disparate) sources. For example, the one or more real-time data streams may include be received from IoT devices, wearable devices, sensors (e.g., thermometers,, accelerometers, etc.), cameras, microphones, mobile devices (e.g., such as a smartphone, tablet, etc.), personal computing devices (e.g., computers, databases, servers, etc. operated by or associated with the one or more related users), websites or web services associated with the one or more related users, communication sessions of the AI Agent Platform (e.g., such as communications between the one or more users and an automated communication service, communications between the one or more users and a terminal device, etc.), combinations thereof, and/or the like.

In some instances, the AI Agent Platform may also receive information from one or more non-real-time data streams. The one or more non-real-time data streams may include information retrieved at regular or irregular intervals. For example, the non-real-time data stream may retrieve information from a webpage every day at the same time (or at varying times). The retrieved information may be timestamped so the AI Agent Platform can identify when the information was posted to the webpage.

The one or more real-time data streams (and/or the one or more non-real-time data streams) may include the homogenous data types or heterogeneous data types. In some instances, the AI Agent Platform may preprocess the received data by translating data received over the one or more real-time data streams (and/or the one or more non-real-time data streams) into one or more common data types. For example, the AI Agent Platform may translate received data into a single common data type. In another example, the AI Agent Platform may translate images into a common image data type (e.g., such as a Joint Photographic Experts Group (JPEG) file, Portable Network Graphics (PNG) file, etc.), video into a common video data type (e.g., such as a Moving Pictures Expert Group (MPEG) based file, etc.), etc.

The AI Agent Platform may define a dataset from the one or more real-time data streams. The dataset may correspond to a portion of data from the one or more real-time data streams. In some instances, the AI Agent Platform may sample the real-time data stream according to a time window. The time window may be defined based on the family profile, user input, the one or more machine-learning models of the AI Agent Platform, an identification of the one or more real-time data streams, data types of the one or more real-time data streams, a time of day, a quantity or frequency of data received over the one or more real-time data streams, combinations thereof, and/or the like. The family profile may store information received from the one or more related users and information associated with the one or more related users (e.g., received by the AI Agent Platform, derived by the AI Agent Platform, and/or the like). The family profile may provide historical information associated the one or more related users and the AI Agent Platform such as a quantity of data received by the AI Agent Platform, a time over which particular data or data types are received by the AI Agent Platform, etc. For example, the AI Agent Platform may use the family profile to define a size of the window to sample the one or more real-time data streams based on when particular data or data types are likely to be included in the one or more real-time data streams (e.g., such as when particular calendar data, sensor data, IoT data, etc. is likely to be included in the one or more real-time data streams, etc.).

In some instances, the window may be defined based a time interval associated with the one or more related users such as time after the one or more related users wake up, when the one or more related users return home, when the one or more related users go to sleep, etc. For example, the time window may be defined to sample a portion of the one or more real-time data streams corresponding to when the one or more related users are home and awake (e.g., increasing a likelihood that the data of the one or more real-time data streams correspond to user activities, etc.). Alternatively, or additionally, the window may be defined using data of the one or more real-time data streams (e.g., such as sensor data indicative of a user presence, user activity, etc.).

In some instances, the AI Agent Platform may sample the one or more real-time data streams based on the data received by each real-time data stream. The AI Agent Platform may define a different window for each real-time data stream based on any of the aforementioned factors. For instance, the AI Agent Platform may sample a thermometer sensor using a small window, because a temperature of a user environment is unlikely to experience rapid changes in temperature and few data points are needed to by the AI Agent Platform. A work calendar may be sampled using a larger window to capture more information about the user, user availability, and changes to the calendar.

The AI Agent Platform may detect, based on the dataset, a correspondence between a portion of the dataset and an event of an event registry. The event registry includes an identification of proactive events with a predicted significance for a user of the one or more related users. The AI Agent Platform may include one or more machine-learning models configured to process user communications, the family profile, etc. The one or more machine-learning models may identify proactive events (e.g., an activity or experience, etc.) that the user will likely be interested to attend. For example, the AI Agent Platform may determine that user likes a particular soccer team based on communications between the user and an automated communication service about the particular soccer team. The AI Agent Platform may store a proactive event in the event registry associated with the particular soccer team. The event registry may include conditions for each proactive event associated with the proactive event and/or the user. For example, the proactive event associated with the particular soccer team may include conditions such as, but not limited to, an upcoming game scheduled for a city near the user, a determination that the user is free on the date/time of the game, and/or the like.

The AI Agent Platform may determine that the dataset corresponds to a particular proactive event within the event registry. The AI Agent Platform may then determine if the conditions associated with event are satisfied based on the dataset, the user profile, etc. Returning to the previous example, the AI Agent Platform may determine from the dataset that the particular soccer team has an upcoming game and that the user of the one or more related users is available on the data of the game (e.g., based on calendar, communications, etc.). If the AI Agent Platform determines the dataset includes partial data (e.g., an indication of an upcoming game, but not the availability of the user, etc.) associated with the proactive event, the AI Agent Platform may obtain another dataset (e.g., with large window sizes to including a large quantity of data, etc.), obtain the missing data from another source (e.g., from another real-time data stream, a non-real-time data stream, a website, a terminal device, another user, etc.), request the missing information from the user (e.g., via natural language communications from an automated communications service, an admin user, etc.), combinations thereof, and/or the like.

In response to detecting the correspondence between the portion of the dataset and the event of the event registry, The AI Agent Platform may execute a machine-learning model using an identification of the proactive event, the dataset, and the family profile. The machine-learning model may be a machine-learning model of the one or more machine-learning models of the AI Agent Platform. The machine-learning model may be configured to define an implementation of the proactive event for the user. The machine-learning model may access one or more application programming interfaces and/or code libraries to enable communication with remote services. Alternatively, or additionally the one or more application programming interfaces and/or code libraries may also enable invoking internal and external services directly by the AI Agent Platform. The one or more application programming interfaces and/or code libraries may be stored in memory of AI Agent Platform (e.g., local memory and/or remote memory, etc.), part of the machine-learning model, and/or stored by the remote service (e.g., accessible to the AI Agent Platform through one or more local APIs and/or code libraries, etc.).

For example, the machine-learning model may generate an identification of a set of tasks that may be implemented by the AI Agent Platform and/or the user to execute the proactive event such as, but not limited to, such as traveling information, tickets, transportation, accommodations, food, etc. Each task may include an identification of when the task should be executed, inputs to execute the task (e.g., resources to acquire tickets, the tickets, reservation information, etc.), and/or the like. If the AI Agent Platform is configured to execute the implementation of the proactive event, then each task may also include executable instructions that may be executed by the AI Agent Platform and/or one or more remote devices to facilitate execution of the tasks. For instance, the AI Agent Platform may generate executable instructions using a code library and one or more APIs. The executable instructions may invoke a remote web service of a ticket platform to acquire tickets to an event, make reservations, etc.

For example, the implementation of the soccer game may include instructions that invoke a travel service to reserve transportation (e.g., a rideshare, train tickets, flights, etc.), instructions that invoke an internal service or external service for defining travel information (e.g., travel routes, etc.), instructions that invoke a webservice of a ticket platform to identify information on tickets and/or obtain tickets, etc. The AI Agent Platform may present the implementation of the proactive event to the user via an interface of the AI Agent Platform, the automated communication service, a terminal device, email, push notifications, combinations thereof, and/or the like. If the AI Agent Platform receives approval from the user, the AI Agent platform may execute the instructions to provide particular information, make reservations, acquire tickets, etc.

Examples of machine-learning models that may be trained to predict the one or more options include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

The machine-learning model may be trained or updated using historical operations of the AI Agent Platform, family profile, communications of the AI Agent Platform, procedurally and/or manually generated data, data from one or more databases, web-based data (e.g., from a web-crawler, etc.), combinations thereof, and/or the like. The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

The AI Agent Platform may receive authorization from the user to execute the proactive event.

In response to receiving authorization to execute the event, the AI Agent Platform may execute the implementation of the event by securing the execution details for the user such as, but not limited to, acquiring tickets, reserving transportation or a hotel, making reservations are restaurants, etc.

In another illustrative example, an AI Agent Platform may receive communications from a communication session between a user and an automated communication service. The automated communication service is configured to converse with the user using natural language communications. The automated communication service is configured to invoke a machine-learning model (e.g., such as any of the aforementioned machine-learning models) to generate an implementation of task for execution on behalf of the user in response to receiving a request associated with the task over the communication channel. For example, a user may communicate with an automated communication service to request tickets to soccer game of a particular soccer team. The automated communication service includes a classifier configured to identify particular types of requests within communications received from users. The particular types of requests include queries, requests for the AI Agent Platform to perform an action, request for the AI Agent Platform to generate an implementation of an event, request for the AI Agent Platform to define tasks of an event, etc. The automated communication service determines an action to execute based on the types of requests. For instance, the automated communication service may facilitate execution of a machine-learning model of the AI Agent Platform to generate an implementation of an event or task, establish a connection with a terminal device or admin user thereof, request additional information, retrieve requested information, etc.

The AI Agent Platform may execute the machine-learning model using the communications. For example, the automated communication service may identify a particular request within the communications of the communication session that may be resolved by the machine-learning model (e.g., such as request to generate an implementation of an event, etc.). For example, the particular request may be associated with a task that user intends to execute. The automated communication service may output instructions to the AI Agent Platform to execute the machine-learning model. The instructions may include the communication, an identification of the particular request, combinations thereof, and/or the like. The AI Agent Platform may define a feature vector from the communication, an identification of the particular request, combinations thereof, and/or the like. In some examples, the AI Agent Platform may also use the family profile associated with the user to generate the feature vector. The family profile includes information associated with the user (e.g., an identification of the user, demographic information, family information, scheduling information, information associated previous communications from the user, information associated previous requests of the user, interests and/or preferences of the user, combinations thereof, and/or the like).

The machine-learning model may generate a probability that the machine-learning model can generate an implementation of the task (of the particular request). The machine-learning model may be configured to define implementations for various tasks and task types. The machine-learning model may determine if, based on the task type, particular request, and/or the communication whether the machine-learning model is capable of generating an implementation of the task. In some instances, the machine-learning model may define the probability based on the availability of processing resources, particular information that may be needed to generate the implementation of the task, a quantity of steps (sub tasks) associated with the task, etc. For example, the task may correspond to a request for tickets to a soccer game. The machine-learning model may use the task and user profile to determine what information is needed to execute the task (e.g., the particular soccer game the request corresponds to, the date and time of the game, the types of ticket to acquire, transportation to and from the soccer game, whether the user is available to attend the soccer game, etc.) and whether the machine-learning model has access to that information (e.g., website information, a calendar of the user, etc.). In some instances, tasks may be associated with a task template (e.g., a set of steps and/or information needed to execute the task, etc.). The task template may be defined by a user, an admit user, defined by the machine-learning model (e.g., based on previous successful operations of the AI Agent Platform, etc.).

The machine-learning model may generate the probability further based on the probability on the ability of the AI Agent Platform to implement the task and/or the steps. For example, for a task associated with tickets to a soccer game, the machine-learning model may determine if the AI Agent Platform includes an application programming interface (API) to enable the AI Agent Platform to automatically acquire the tickets to the soccer game (e.g., from a webpage associated with the soccer team and using resources associated with the user, etc.), add the soccer game to a calendar of associated with the user, etc.

If the machine-learning model determines that the information needed is available and/or the AI Agent Platform has the capability to implement the task or steps, then the machine-learning model may output at high probability. If the machine-learning model cannot determine what information is needed, if the information is unavailable, and/or if the AI Agent Platform is unable to execute portions of the task or steps, then the machine-learning model may output a low probability. In some examples, the machine-learning model may weight particular types of information needed for generating the implementation of the task or implementing the task. The weights may be based on the degree in which any unavailable information can be obtained from additional sources (e.g., webpages, the user, an admin user, the data streams, etc.), a source of needed information being known, the user and/or the admin user being available, an interface to access information, an interface to implement a step or the task, combinations thereof, and/or the like. For example, information that is unavailable, but associated with a known source (e.g., such as an accessible database, the user via a request for the information from the automated communication service, etc.) may be weighted lower (e.g., have lower impact on the probability, etc.) than information that in unavailable with an unknown source (e.g., causing a higher impact to the probability due the machine-learning model being unable to determine how to access the missing information). A task that cannot be implemented by the machine-learning model or AI Agent Platform may be weighted highest (e.g., having a largest impact on the probability).

The AI Agent Platform may determine that the probability is less than a threshold. The threshold may be defined based on user input, admin user input, the AI Agent Platform (e.g., based on historical operations of the AI Agent Platform, etc.), and/or the like. A probability that is less than the threshold is an indication that the AI Agent Platform cannot generate an implementation of the task and/or implement the task (e.g., because the task is too complex for the machine-learning model, there is insufficient information to generate the implementation of the task or implement task, any missing information needed to generate the implementation of the task or implement task is not accessible and/or known, the machine-learning model and/or the AI Agent Platform is incapable of implementing the task or steps of the task, combinations thereof, and/or the like).

In response to determining that the probability is less than the threshold, the AI Agent Platform connects a terminal device to the communication session. The terminal device is operated by agent (i.e., an admin user) configured to process the communication in place of the automated communication service. Some tasks and/or steps of tasks cannot be implemented (e.g., due to any of the aforementioned reasons, etc.). The AI Agent Platform connects additional processing resources (e.g., the terminal device and admin user) to the communication session to facilitate implementation of the task to maintain processing of communications by the AI Agent Platform. For example, the task may be implemented using voice communications over a telephone that cannot be implemented by the automated communication service or AI Agent platform. In response, the AI Agent Platform connects a terminal device and uses the admin user to implement the steps of the task, the task, and/or the like in place of the automated communication service. In some instances, the user is not notified that the terminal device is connected to create a seamless experience for the user (e.g., the user is unaware that the admin user implemented the task instead of the automated communication service and instead just detects the task being implemented). Once the task, steps of the task, and/or the like are implemented by the terminal device or admin user, the terminal device may be disconnected from the communication session and the communications may resume between the user and the automated communication service.

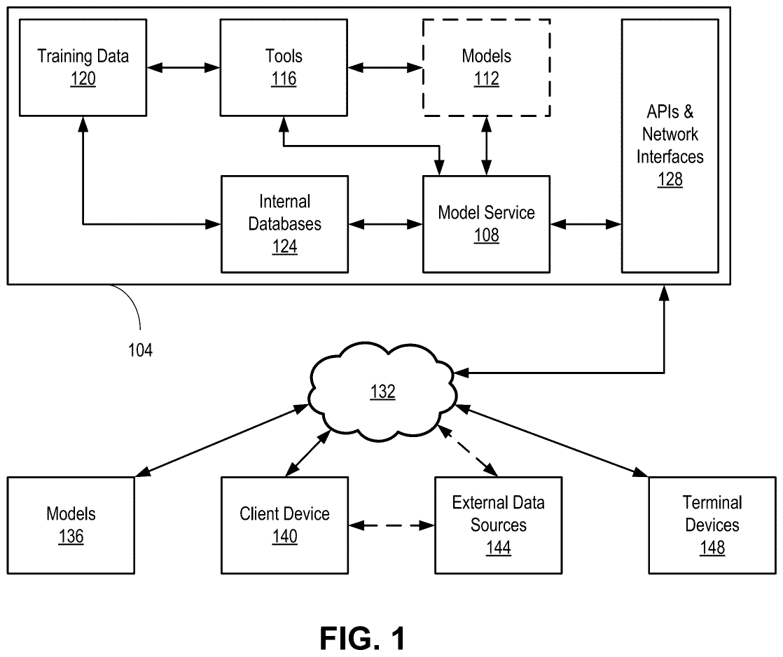

FIG. 1 illustrates a block diagram of an example AI Agent Platform that provides natural language communication processing for task facilitation according to aspects of the present disclosure. AI Agent Platform 104 may operate as a hardware platform (e.g., as a application specific integrated circuit (ASIC), field programmable gate array (FPGA), special-purpose processing device, combinations thereof, and/or the like), a software platform (e.g., executing on a computing device, server, cloud network, a hardware platform as previously described, combinations thereof, and/or the like), or as a combination of a hardware platform and a software platform.

AI Agent Platform 104 is configured to communicate with users using natural language communications, process natural language communications to identify and implement tasks and events, and dynamically connect devices to communication sessions for fault tolerant continuity of services. Model service 108 (e.g., also referred to as an orchestrator) may manage the operations of AI Agent Platform 104 such as instantiating and executing one or more machine-learning models (e.g., such as models 112, models 136, etc.), analytics and performance monitoring via tools 116, data management via such as training data 120 and internal databases 124, and/or the like.

For example, model service 108 may receive communications from external sources via APIs and network interfaces 128. APIs and network interfaces 128 include interfaces (e.g., software and/or hardware interface) that enable communications with disparate device types. For example, AI Agent Platform 104 may receive natural language communications from client device 140 via APIs and network interfaces 128, data from one or more external data sources 144 (e.g., information from sensors, IoT devices, surveillance devices such as cameras and/or microphones, databases, cloud networks, websites, servers, etc.), terminal devices 148, etc. APIs and network interfaces 128 may include interfaces to translate information into a format that that can be processed by AI Agent Platform 104. In some examples, APIs and network interfaces 128 may translate particular data types into common data types. For instance, image data may be translated into an image data type, audio segments may be translated into an audio data type, video data may be translated into a video data type, etc. APIs and network interfaces 128 may pass communications and data to model service 108 for further processing.

When a user of client device 140 connects to AI Agent Platform 104, model service 108 may determine if there is a family profile associated with client device 140 and/or the user thereof stored in internal databases 124. The family profile may include information known about the user including, but not limited to, information received from the user, communications between the user and AI Agent Platform 104 (e.g., such as communications with automated communication services, terminal devices 148, admin users, etc.), information associated with the user (e.g., information generated through operations of AI Agent Platform 104, etc.), demographic information, family information, combinations thereof, and/or the like. AI Agent Platform 104 may add to the family profile each time there is an interaction with the user or information associated with the user is generated. The family profile may be used to bias operations of AI Agent Platform 104 to the user, which may customize responses to the user. If no family profile can be identified, then model service 108 may identify a family profile associated with a related user to the user (e.g., such as family member, etc.), which may include references to the user. If no such family profile can be identified, then model service 108 may instantiate a new family profile by requesting predetermined information from the user.

Model service 108 may process communications from client device 140 and (optionally) other client devices. Model service 108 may establish a communication session for client device 140 when client device 140 connects to AI Agent Platform 104. The communication session may be an environment through which real-time and/or non-real-time communications can be exchanged between client device 140 and AI Agent Platform 104. In some instances, model service 108 may select an automated communication service to communicate with client device 140 via the communication session. The automated communication service may process natural language communications in any format (e.g., alphanumeric text, audio segments, video segments, and/or the like). In some instances, the automated communication service may include one or more models that can parse communications and generate responses (e.g., such as natural language models, large language models, etc.). In other instances, the automated communication service may include non-machine-learning algorithms, which may use less processing resources at the expense of more limited communication functionality.

AI Agent Platform 104 may operate one or more machine-learning model that provide some of the operations of AI Agent Platform 104 such as automated communication services, identification of tasks and/or events, processing real-time and non-real-time data streams, generating implementations of tasks and/or events, combinations thereof, and/or the like. In some examples, AI Agent Platform 104 may include one or more machine-learning models in models 112. These one or more machine-learning models may be instantiated, trained, and/or operated by model service 108. Alternatively, or additionally, AI Agent Platform 104 may access one or more external machine-learning models in models 136. The one or more external machine-learning models may be operated by model service 108 to provide various operations of AI Agent Platform 104.

Examples of machine-learning models that may be trained to predict the one or more options include, but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), etc.), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

Model service 108 may train the one or more machine-learning models using historical operations of AI Agent Platform 104, the family profile associated with client device 140, communications of the client device 140, procedurally and/or manually generated data, data from one or more databases, web-based data (e.g., from a web-crawler, etc.), combinations thereof, and/or the like. For example, model service 108 may store information received from client device 140, information associated with client device 140 and/or the user thereof, etc. in internal databases 124. AI Agent Platform 104 may use the information to define a family profile of the user in internal databases 124. The family profile may also include information associated with one or more related users such as users that are related to the user (e.g., family, etc.), users in a same household, etc. Operations of the one or more machine-learning models may be evaluated by tools 116 (e.g., accuracy metrics, operations data, user feedback, admin user feedback, etc.), feedback from client device 140 and/or the user thereof, terminal devices 148 and/or the admin users thereof, and/or the like. Training data 120 may include the evaluation data from tools 116 and data from internal databases 124. Model service 108 may train the one or more machine-learning models of models 112 using tools 116 to access training data 120. Tools 116 may pass the training data to models 112 and model service 108 may manage the training iterations.

The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

In some examples, AI Agent platform may receive input from client device 140 (and/or the user thereof) requesting various services of AI Agent Platform 104 over the communication session. The input may include natural language communications (e.g., alphanumeric text, audio segments, video segments, and/or any combinations thereof), gestures, sensor data, video segments, audio segments, images, unstructured data, structured data, events, and/or any other data. For example, client device 140 may request implementation of an event or task (e.g., such as, but not limited to, acquisition of a product or service, implementation of an experience, a query for information, etc.). Model service 108 may process the input to identify the task and/or a task type. Model service 108 may retrieve additional information associated with the user and the request such as, but not limited to, the family profile, client device 140, one or more external data sources 144, combinations thereof, and/or the like, the event or task, and/or the like. Model service 108 may then process the task and/or event for the user.

AI Agent Platform 104 may also be configured for autonomous processing based on data detected via one or more data streams (e.g., such as real-time data streams and/or non-real-time data streams comprising data from one or more external data sources 144, internal databases 124, and/or any other information associated with client device 140 and/or the user thereof). Model service 108 may define discrete datasets from the one or more data streams. The discrete datasets correspond to a portion of data selected using a moving window. The size of the window and/or the rate in which the window moves may be selected to moderate the amount of data from each one or more data streams included in the dataset. The size of the window and/or the rate in which the window moves may be selected per data stream based on quantity of data of the data stream, a frequency new data is added to the data stream, a rate in which data of the data stream changes, a time of day in which data is added to the data stream, etc. For example, the size of the window and/or the rate of the window of a data stream of sensor data may be selected based on the rate in which the data changes and the time of day in which the data is likely to be relevant to AI Agent Platform 104. A thermostat, for example, may not change frequently and the data values may be more relevant in the morning and evenings when the user is likely to be present. Thus, a window for a data stream including thermostat data may have a window that captures data in the mornings and evenings (or whenever the user is detected to be present, etc.).

Model service 108 may also process the datasets to detect a correspondence between data of a data stream and an event of an event registry. The event registry may store an identification of events that may be significant to the user such as events that AI Agent Platform 104 predicts will be of interest to the user, events designated by the user, etc. The events may also include events associated with data streams (e.g., anomalous sensor data and/or data outside of average ranges or threshold ranges, etc.). For instance, an event may be generated when temperature measurements exceed average temperature measurements by more than a threshold amount over a time interval. Each event includes one or more conditions. Model service 108 determines a correspondence by monitoring datasets to determine if the one or more conditions of an event are satisfied. If the conditions of an event are satisfied, model service 108 may define a task to generate an implementation of the event using one or more machine-learning models of models 112 or models 136. The implementation may include logistical parameters enabling the user to attend the event, execute a home repair, query an information source, etc. For instance, the implementation of an event for the user to attend may include, but is not limited to transportation, tickets, travel routes, reservations for food or hotels, etc.

In some instances, model service 108 may execute an identified task directly (e.g., tasks identified from an input and/or implementations of events, etc.). In other instances, model service 108 may invoke a machine-learning model of models 112 (e.g., referred to as a specialist machine-learning model) to execute the task. Specialist machine-learning models may be trained to execute particular tasks to task types. The specialist machine-learning model may execute the task directly or divide the task into a set of subtasks that when executed, implement the task. The set of subtasks may be executed in series, in parallel, and/or any combinations thereof. For instance, some subtasks may be dependent on other subtasks causing the subtasks to execute sequentially. Other subtasks may not include dependencies or may only be dependent on some subtasks. These subtasks may be executed in parallel with other subtasks. The specialist machine-learning model may define an execution schedule for the subtasks. The execution order may be based primarily on dependencies between the subtasks but may also be based on execution efficiency (e.g., load balancing, resource utilization, etc.), execution security (e.g., fault tolerance, etc.), an execution rate, combinations thereof, and/or the like. For instance, the specialist module may define the execution order of subtasks according to dependencies, then optimize the execution order to improve an execution rate (e.g., by executing any non-dependent-based subtasks in parallel with other subtasks, etc.), resource utilization (e.g., by executing subtasks sequentially to reduce a processing resource utilization, etc.), execution security (e.g., by executing subtasks in an order that reduces a likelihood of generating faults or in an order in which recovering from a fault is more likely, etc.), and/or the like.

Model service 108 may determine whether to execute a task directly or to invoke a specialist machine-learning model of models 112 to execute the task. For instance, model service 108 may include a classifier and/or decisioning module configured to determine how to route tasks including tasks that can be executed directly by model service 108. In some instances, model service 108 may execute any task that model service 108 is capable of executing directly and invoke a specialist machine-learning model for tasks that model service 108 cannot execute directly. In other instances, model service 108 may determine whether to execute tasks directly or to invoke a machine-learning model based on execution efficiency, execution security, and/or the like. For instance, model service 108 may determine when to pass tasks that can be executed by model service 108 directly to maximize an execution rate, etc. In still yet other instances, model service 108 may pass all tasks to a specialist machine-learning model regardless of whether model service 108 is capable of executing a task directly.

In some instances, the specialist machine-learning models of models 112 may execute tasks received from model service 108. Alternatively, or additionally, the specialist machine-learning models may divide the task into a set of subtasks that can be executed by the specialist machine-learning model and/or other machine-learning models of models 112 (e.g., also referred to as agent machine-learning models). For instance, the model service 108 may select a specialist machine-learning model to execute a task. The specialist machine-learning model may be configured to plan execution of tasks by defining subtasks that when executed cause the overall task to be implemented. The specialist machine-learning model may define an execution sequence (e.g., based on processing resource efficiency, task or subtask type, a current processing load, an execution rate, etc.). The specialist machine-learning model may then execute the set of subtasks, execute any subtask thereof, or distribute the set of subtasks to one or more agent machine-learning models of models 112. The agent machine-learning models may be trained to implement discrete tasks or subtask types. Agent machine-learning models may operate as an interchangeable pool of resources that can be invoked by specialist machine-learning models and/or by model service 108. Models 112 may store any number of specialist machine-learning models and/or agent machine-learning models.

In some instances, models 112 may not include a specialist machine-learning model configured to execute a task and/or agent machine-learning models configured to execute a subtask. In those instances, model service 108 may invoke one or more external models of models 136. Models 136 may include one or more third-party machine-learning models, large language models, other large models, etc. Models 136 may be invoked when model service 108 determines that models 112 lacks the capability to execute a task or subtask and/or when invoking an external machine-learning model will improve execution efficiency, an execution rate, execution security, and/or the like. Model service 108 may be weighted to bias task execution decisions towards models 112 (e.g., reducing a likelihood of invoking external machine-learning models of models 136). Internal models are more secure and less likely to leak sensitive user data. Model service 108 may attempt to execute tasks and/or subtasks internally before invoking external models. Alternatively, or additionally, model service 108 may invoke external machine-learning models of models 136 for tasks and/or subtasks when execution of the tasks and/or subtasks by model service 108 and/or a machine-learning model of models 112 is not possible. Alternatively, or additionally, model service 108 may invoke external machine-learning models of models 136 to manage processing resources of AI Agent Platform 104, load balancing, improve a task execution rate, user input, combinations thereof, and/or the like. For instance, model service 108 may pass tasks to an external machine-learning model of models 136 when AI Agent Platform 104 is operation at a high processing load to enable timely execution of the task.

AI Agent Platform 104 may be configured for fault tolerance for continuity of services. If model service 108 detects a processing fault (e.g., communications that cannot be parsed or semantically classified, the one or more machine-learning models cannot generate an implementation of an event or task, the one or more machine-learning models cannot automatically execute an event or task, etc.), then model service 108 may automatically connect a terminal device of terminal devices 148. Terminal devices 148 may be operated by admin users of AI Agent Platform 104 and may be configured to resolve processing faults by executing the operations of AI Agent Platform 104 that caused the fault. For instance, a task that can only be executed by calling an individual over a telephone may not be executed by the automated communication service. Instead, model service 108 may automatically connect a terminal device and the admin user may process the task. Once the task is processed, the terminal device may be disconnected.

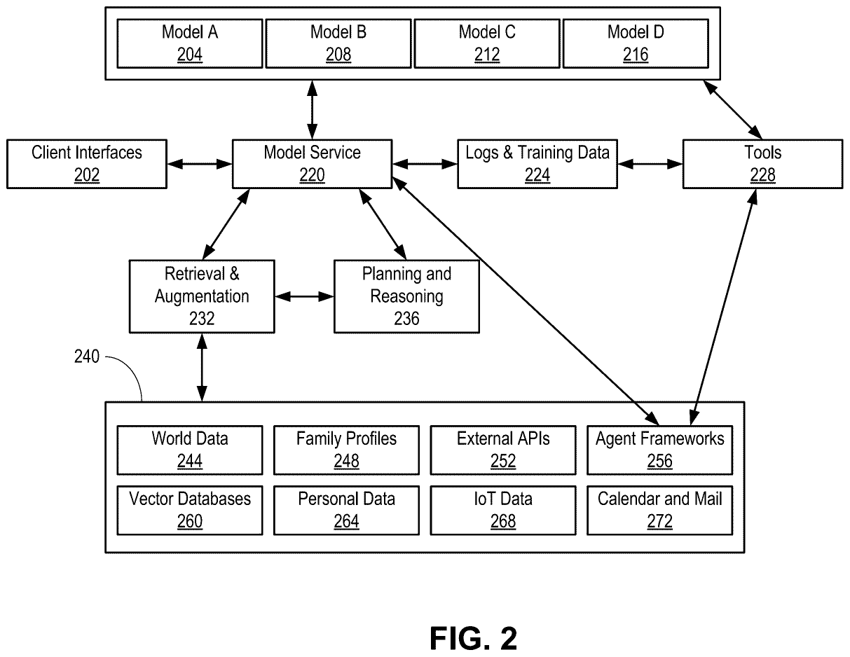

FIG. 2 illustrates a block diagram of components an AI Agent Platform according to aspects of the present disclosure. AI Agent Platform 200 includes components for processing communications and data streams for event and task implementation. Model service 220 (e.g., similar to or the same as model service 108 of FIG. 1) may manage operations of one or more machine-learning models such as Model A 204, Model B 208, Model C 212, Model D 216, etc. The one or more machine-learning models may be hosted by AI Agent Platform 200 or by one or more external sources (e.g., remote servers, computing devices, etc.). Each model may trained using particular training datasets and training methodologies, which may cause each model to process data differently or produce different outputs. Model service 220 may select a particular model for execution or receive user input selecting a particular model.

Model service 220 generates an implementation of a task or event or processes a data stream (e.g., autonomously or based on user input), model service 220 may select a particular model for execution or receive user input selecting a particular model. For instance, a user may transmit a communication to AI Agent Platform 200 through client interface 202. Client interface 202 (e.g., such as a web-based interface, I/O interface, etc.). Client interface 202 pass the communication to model service 220. Model service 220 prepares an input feature vector, selects a model and pass the input feature vector to the model. Model service 220 receives the output from the model, verifies the output (e.g., using tools 228, data sources 240, etc.), and pass the output to the user via client interface 202.

Tools 228 receives the output from the model and executes various metrics to qualify the output. For instance, tools 228 may execute one or more accuracy metrics, determine corrections (for incorrect data or parameters, etc.) assign ratings (e.g., such as when more than model is used to compare outputs, etc.). Logs & and training data 224 store the various metrics from tools 228 for use define training data (for training the models, model service 220, updating data sources 240, etc.). For example, model service 220 may use logs & training data 224 to update data included in feature vectors to improve the outputs from a model, execute training iterations (e.g., for reinforcement learning, transfer learning, metalearning, etc.).

Model service 220 uses planning and reasoning 236 to generate implementations of events and tasks. Planning and reasoning 236 defines a set of steps (e.g., subtasks, etc.) that can be executed to generate an implementation of a task or event (or execute the task or event). In some instances, planning and reasoning 236 uses a feedback loop to define the set of steps. The feedback loop includes executing a model to define steps of a task or event, then executing the model again for each step to define sub-steps for the step if needed. If planning and reasoning 236 determines that a step can be implemented by one or more sub-steps then planning and reasoning 236 may replace the step with the sub-steps replace and executes the model to define one or more sub-steps for each sub-step. Planning and reasoning 236 may determine when to define additional sub-steps and/or replace steps with sub-steps based on characteristics of the step and/or a state of AI Agent Platform 200 (e.g., using one or more of: algorithms, classifiers, user input, and/or the like). In one example, planning and reasoning 236 may use a task type and a current resource consumption of AI Agent Platform 200 to replace a step with sub-steps when resource consumption is low (e.g., for faster task execution, etc.) and not replace the step with the sub-step when resource consumption is high. In another example, planning and reasoning 236 may replace a step with sub-steps when the step is too complex to be executed or when the execution of the step is likely to result in an error or an inaccurate output.

AI Agent Platform 200 may include different types of machine-learning models with each machine-learning model trained to execute different tasks, steps, and/or sub-step types. For instance, AI Agent Platform may include an orchestrator service (e.g., such as model service 220, a machine-learning model, and/or a process configured to invoke a machine-learning model) that manage execution of a task, assigns steps and/or sub-steps to other machine-learning models, tracks the execution state of tasks and steps, etc. The orchestrator service may use planning and reasoning 236 to define steps for a task and assign those steps to one or more specialist machine-learning models. Each specialist machine-learning model may be trained to execute tasks of a particular type. In some instances, each specialist machine-learning model may include a planning and reasoning service to divide steps into sub-steps and schedule execution of steps and/or sub-steps, a state tracking module (e.g., that tracks the state of the step assigned to the specialist machine-learning model, and/or one or more processors (e.g., machine-learning models, algorithms, and/or components of the specialist machine-learning model configured to execute steps and/or sub-steps). Specialist machine-learning models may use its internal planning and reasoning to determine whether to define sub-tasks for an assigned step and whether to execute the task/sub-tasks directly (e.g., using one or more processors, etc.) or to assign the task/sub-tasks to one or more define sub-steps for an assign step and determine whether to assign the sub-steps to an agent machine-learning model.

Agent machine-learning models may be machine-learning models configured to execute sub-steps. Agents machine-learning models can be invoked by specialist machine-learning models or by the orchestrator service directly. Agent machine-learning models may be interchangeable and chained together to enable execution of various steps and/or sub-steps. The process may continue until planning and reasoning 236 defines a set of steps for model service 220.

Retrieval & augmentation 232 retrieves information from data sources 240 and augments retrieved data to improve operations of model service 220 and models. In some instances, retrieval & augmentation 232 uses retrieval-augmented generation. Retrieval & augmentation 232 may identify data from data sources using probabilistic search, embeddings, keywords, tags, and/or the like.

Data sources 240 includes an identification of data usable by retrieval & augmentation 232, model service 220, and tools 228. Data sources 240 may correspond to data stored internally (e.g., by AI Agent Platform 200) or externally (e.g., one or more servers, databases, websites, computing devices, mobile devices, etc.). For example, world data 244 may include data retrieved from or hosted by sources that are not affiliated with AI Agent Platform 200 such as web-based data or any publicly available data source. World data 244 may use a web crawler for generalized data gathering or query to access particular data. In some instances, world data 244 may be transmitted over a data stream that AI Agent Platform 200 can connect to access particular data such as requested data, subscribed data, etc. Family profiles 248 stores family profiles associated with users of AI Agent Platform 200. Family profiles may be stored in memory accessible by AI Agent Platform 200 and/or in memory of a computing device of the users. Vector databases 260 store information received by data sources 240, information generated by AI Agent Platform 200, metadata (e.g., such as embeddings, etc.). Personal data 264 stores personal information associated with individual users and families such as, but not limited to, demographic information, connections to other users, intents, preferences, payment information, combinations thereof, and/or the like. In some instances, personal data 264 may be included in family profiles 248.

External APIs store application programming interfaces, code libraries, and other interfaces usable to access external data sources and devices, such as, but not limited to, IoT devices for IoT data 268, external services (e.g., such as calendar and mail 272) computing devices operated by users, terminal devices operated by admin users, servers, databases, etc. AI Agent Platform 200 may receive APIs to communicate with new devices when the new devices register with AI Agent Platform 200. Alternatively, or additionally, AI Agent Platform 200 may define APIs for new devices based on information that can be detected from the new devices AI Agent Platform 200 may generate executable instructions from the APIs, code libraries, and/or interfaces to communicate with external data sources and devices. AI Agent Platform 200 may also generate executable instructions from the APIs, code libraries, and/or interfaces to invoke functions and/or services of external data sources and devices.

For example, AI Agent Platform 200 may generate instructions that translate a request for information (e.g., such as connections to sensor data stream, queries, etc.) into a native protocol of an external data source. In another example, AI Agent Platform may generate executable instructions that when executed, execute functions of external data sources to access data of the external data source directly. The executable instructions may communicate with external data sources and/or devices via APIs of AI Agent Platform 200, code libraries of AI Agent Platform 200, other interfaces of AI Agent Platform 200, APIs of the external data sources and/or devices, code libraries of the external data sources and/or devices, other interfaces of the external data sources and/or devices, one or more other data protocols (e.g., such as, but not limited to, remote procedure calls (RPC), simple object access protocol (SOAP), common object request broker architecture (CORBA), Action Message Format, combinations thereof, and/or the like), combinations thereof, and/or the like.

In still another example, the external data sources and/or devices may be connected to AI Agent Platform 200 (e.g., via a wired or wireless connection) and stream data to AI Agent Platform 200. In that example, AI Agent Platform 200 may generate instructions to process the incoming data stream into structured datasets. For instance, incoming data may appear to AI Agent Platform 200 random bits as AI Agent Platform 200 may not have information about the structure of the data stream, data being transmitted over the data stream, etc. AI Agent Platform 200 may use APIs, code libraries, and/or interfaces (as well as any of the aforementioned communication protocols) to identify the data structure of the data stream, identify data types and values, etc. In some instances, AI Agent Platform may process the data stream to discover the data structure of the data stream. In other instances, AI Agent Platform 200 may receive an identification of the data structure of the data stream from the remote data source and/or device streaming the data stream.

For example, AI Agent Platform 200 may use APIs, code libraries, and/or other interfaces to generate executable instructions for access calendar applications and/or mail applications (e.g., calendar and mail 272, etc.). The calendar applications and/or mail applications may be executing devices associated with the user and/or as one or more webservices accessible to the user. The executable instructions, when executed, access the applications and/or mail applications and download appointment data (e.g., including, but not limited to, an identification of the appointment, a date and time of the appointment, a title of the appointment, attachments stored in the appointment, an identification of one or more other users that are also attending the appointment, combinations thereof, and/or the like), mail data (e.g., including, but not limited to, messages, email, contacts, metadata, combinations thereof, and/or the like), etc.

IoT data 268 and other data received from external data sources or devices may be stored in memory AI Agent Platform 200 (e.g., local and/or remote memory, etc.) as one or more datasets. AI Agent Platform 200 may use machine-learning models and/or other processing techniques to process the datasets to provide services to components of AI Agent Platform 200, devices connected to or in communication with AI Agent Platform 200, users of AI Agent Platform 200, etc. AI Agent Platform 200 may process the datasets periodically, in regular intervals, upon detecting an event, and/or the like. For instance, AI Agent Platform 200 may process the datasets once a predetermined quantity of data is received, upon detecting particular data types and/or values, ever n hours, etc. For example, AI Agent Platform 200 may receive an audio segment from an IoT device. The audio segment may include a wake word or command that triggers immediate processing of the audio segment. The audio segment may be stored in IoT data 268 and processed by model service 220 using one or more machine-learning models to identify a task. The one or more machine-learning models may identify a task from the audio segment, a classified context, a classified intent, and/or the like. Model service 220 may invoke the one or more machine-learning models again using the task to define subtasks, execute subtasks, and provide a response to the user. In some instances, AI Agent Platform 200 may transmit the response to the same IoT device that received the audio segment using one or more the aforementioned APIs, code libraries, and/or other interfaces.

Agent framework 256 includes instructions that determine when to connect a terminal device to a communication session of a user. Terminal devices may be operated by admin users (e.g., agents, etc.) that may augment operations of AI Agent Platform 200. For example, admin users may be configured to generate implementation of tasks and events, execute tasks and events, communicate with users, modify model service 220 and/or training operations to improve models, update data sources (e.g., add data sources, remove data sources, add or remove data, etc.), and/or the like. In some instances, tools 228 may determine that a model is not producing an acceptable output. For example, tools 228 may generate a probability that a model is capable of producing an output requested by model service 220 or the user that is less than a threshold probability. Tools 228 may transmit a communication to agent framework 256 causing a terminal device to connect to model service 220 and generate an output requested by the user. In some instances, the terminal device may facilitate generation of the requested output by modifying the input feature vector generated by model service 220. In other instances, the terminal device may generate the requested output.

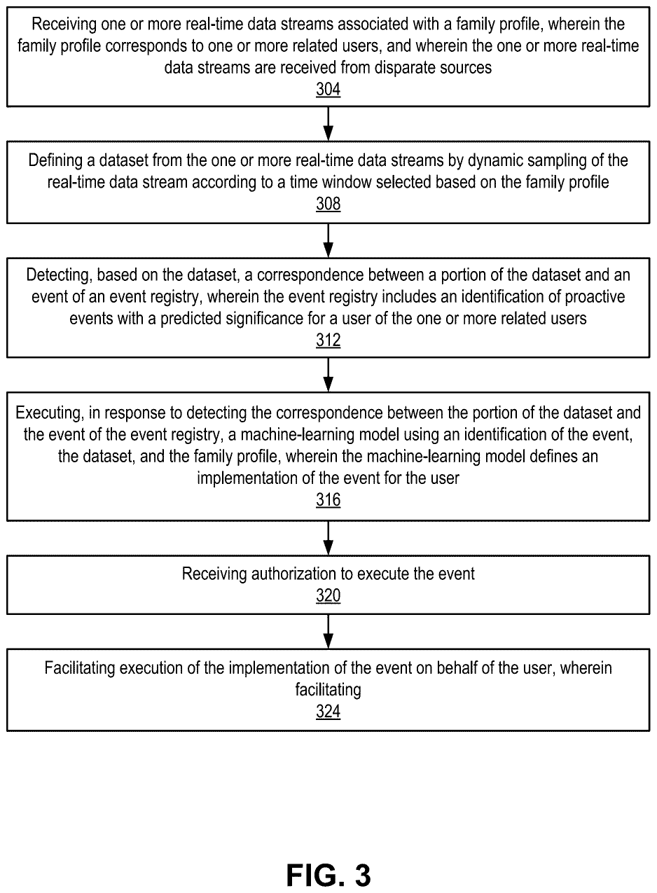

FIG. 3 illustrates a flowchart of an example process for autonomous operations of machine-learning operations that generate events for users according to aspects of the present disclosure. The example process may be executed by a computing device (e.g., such as a processing device of AI Agent Platform 104, a processing device executing a software implementation of AI Agent Platform 104, a processing device executing instructions that access an instance of AI Agent Platform 104, a processing device, a distributed processing device, combinations thereof, and/or the like). At block 304, the computing device may receive one or more real-time data streams associated with a family profile. The family profile may correspond to one or more related users. The one or more real-time data streams may be received from disparate sources. For example, the one or more real-time data streams may include be received from Internet-of-things (IoT) devices, wearable devices, sensors (e.g., thermometers,, accelerometers, etc.), one or more cameras, microphones, mobile devices (e.g., such as a smartphone, tablet, etc.), personal computing devices (e.g., computers, databases, servers, etc. operated by or associated with the one or more related users), websites or web services associated with the one or more related users, communication sessions of the computing device (e.g., such as communications between the one or more users and an automated communication service, communications between the one or more users and a terminal device, etc.), combinations thereof, and/or the like.

In some instances, the computing device may also receive information from one or more non-real-time data streams. The one or more non-real-time data streams may include information retrieved at regular or irregular intervals. For example, the non-real-time data stream may retrieve information from a webpage every day at the same time (or at varying times). The retrieved information may be timestamped enabling the computing device to identify when the information was posted generated and/or uploaded to a data stream.

The one or more real-time data streams (and/or the one or more non-real-time data streams) may include the homogenous data types or heterogeneous data types. In some instances, the computing device may preprocess the received data by translating data received over the one or more real-time data streams (and/or the one or more non-real-time data streams) into one or more common data types. For example, the computing device may translate received data into a single common data type. In another example, the computing device may translate images into a common image data type, video into a common video data type, etc.

The block 308, the computing device may define a dataset from the one or more real-time data streams. The dataset may correspond to a portion of data from the one or more real-time data streams. In some instances, the computing device may sample the real-time data stream according to a time window. The time window may be defined based on the family profile, user input, the one or more machine-learning models of the computing device, an identification of the one or more real-time data streams, data types of the one or more real-time data streams, a time of day, a quantity or frequency of data received over the one or more real-time data streams, combinations thereof, and/or the like. The family profile may store information received from the one or more related users and information associated with the one or more related users (e.g., received by the computing device, derived by the computing device, and/or the like). The family profile may provide historical information associated the one or more related users and the computing device such as a quantity of data received by the computing device, a time over which particular data or data types are received by the computing device, etc. For example, the computing device may use the family profile to define a size of the window to sample the one or more real-time data streams based on when particular data or data types are likely to be included in the one or more real-time data streams (e.g., such as when particular calendar data, sensor data, IoT data, etc. is likely to be included in the one or more real-time data streams, etc.).

In some instances, the window may be defined based a time interval associated with the one or more related users such as time after the one or more related users wake up, when the one or more related users return home, when the one or more related users go to sleep, etc. For example, the time window may be defined to sample a portion of the one or more real-time data streams corresponding to when the one or more related users are home and awake (e.g., increasing a likelihood that the data of the one or more real-time data streams correspond to user activities, etc.). Alternatively, or additionally, the window may be defined using data of the one or more real-time data streams (e.g., such as sensor data indicative of a user presence, user activity, etc.).

In some instances, the computing device may sample the one or more real-time data streams based on the data received by each real-time data stream. The computing device may define a different window for each real-time data stream based on any of the aforementioned factors. For instance, the computing device may sample a thermometer sensor using a small window, because a temperature of a user environment is unlikely to experience rapid changes in temperature and few data points are needed to by the computing device. A work calendar may be sampled using a larger window to capture more information about the user, user availability, and changes to the calendar.

At block 312, the computing device may detect, based on the dataset, a correspondence between a portion of the dataset and an event of an event registry. The event registry includes an identification of proactive events with a predicted significance for a user of the one or more related users. The computing device may include one or more machine-learning models configured to process user communications, the family profile, etc. The one or more machine-learning models may identify proactive events (e.g., an activity or experience, etc.) that the user will likely be interested to attend. For example, the computing device may determine that user likes a particular soccer team based on communications between the user and an automated communication service about the particular soccer team. The computing device may store a proactive event in the event registry associated with the particular soccer team. The event registry may include conditions for each proactive event associated with the proactive event and/or the user. For example, the proactive event associated with the particular soccer team may include conditions such as, but not limited to, an upcoming game scheduled for a city near the user, a determination that the user is free on the date/time of the game, and/or the like.

The computing device may determine that a portion of the dataset corresponds to a particular proactive event within the event registry based on keyword matching (e.g., one or more words associated with the proactive event being detected in the dataset), condition matching (e.g., one or more conditions of a proactive event being satisfied by data of the dataset, etc.), a context combinations thereof, and/or the like. The computing device may then determine if the conditions associated with event are satisfied based on the dataset, the user profile, etc. Returning to the previous example, the computing device may determine from the dataset that the particular soccer team has an upcoming game and that the user of the one or more related users is available on the data of the game (e.g., based on calendar, communications, etc.). If the computing device determines the dataset includes partial data (e.g., an indication of an upcoming game, but not the availability of the user, etc.) associated with the proactive event, the computing device may obtain another dataset (e.g., with large window sizes to including a large quantity of data, etc.), obtain the missing data from another source (e.g., from another real-time data stream, a non-real-time data stream, a website, a terminal device, another user, etc.), request the missing information from the user (e.g., via natural language communications from an automated communications service, an admin user, etc.), combinations thereof, and/or the like.

In response to detecting the correspondence between the portion of the dataset and the event of the event registry, at block 316 the computing device may execute a machine-learning model using an identification of the proactive event, the dataset, and the family profile. The machine-learning model may be configured to define an implementation of the proactive event for the user. For example, the machine-learning model generate an identification of a set of tasks that may be implemented by the computing device and/or the user to execute the proactive event such as, but not limited to, such as traveling information, tickets, transportation, accommodations, food, etc. Each task may include an identification of when the task should be executed, inputs to execute the task (e.g., resources to acquire tickets, the tickets, reservation information, etc.), and/or the like. For example, the implementation of the soccer game may include transportation (e.g., a rideshare, train tickets, flights, etc.), travel information (e.g., travel routes, etc.), an identification of where tickets can be acquired, ticket costs, etc. The computing device may present the implementation of the proactive event to the user via an interface of the computing device, the automated communication service, a terminal device, email, push notifications, combinations thereof, and/or the like.

Examples of machine-learning models that may be trained to predict the one or more options include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

The machine-learning model may be trained or updated using historical operations of the computing device, family profile, communications of the computing device, procedurally and/or manually generated data, data from one or more databases, web-based data (e.g., from a web-crawler, etc.), combinations thereof, and/or the like. The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

At block 320, the computing device may receive authorization to execute the proactive event. In some instances, the computing device may receive authorization to execute the proactive event from the user.

At block 324 and in response to receiving authorization to execute the event, the computing device may execute the implementation of the event by securing the execution details for the user such as, but not limited to, acquiring tickets, reserving transportation or a hotel, making reservations are restaurants, etc.

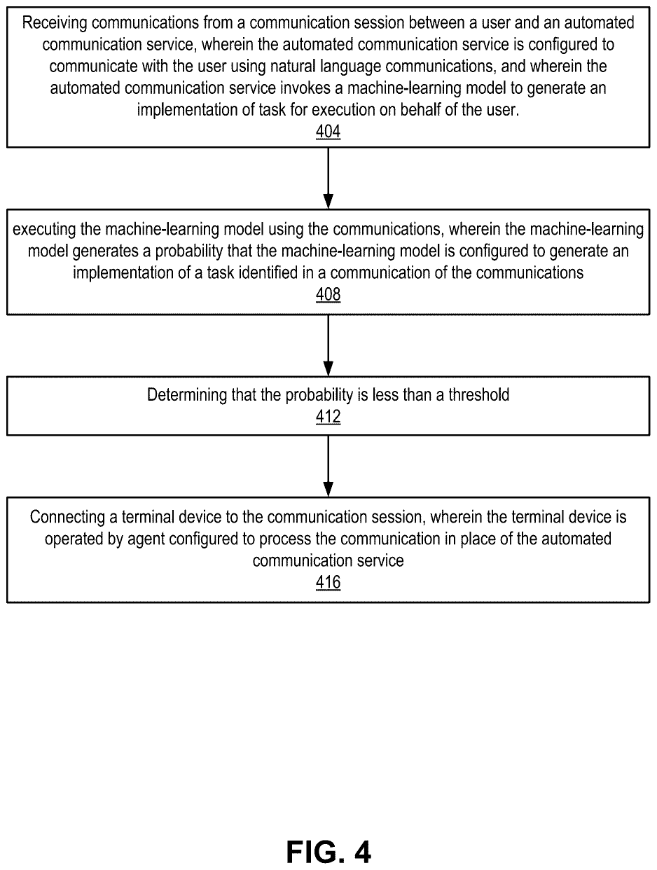

FIG. 4 illustrates a flowchart of an example process for implementing fault tolerant communications within agent platforms according to aspects of the present disclosure. The example process may be executed by a computing device (e.g., such as a processing device of AI Agent Platform 104, a processing device executing a software implementation of AI Agent Platform 104, a processing device executing instructions that access an instance of AI Agent Platform 104, a processing device, a distributed processing device, combinations thereof, and/or the like). At block 404, the computing device may may receive communications from a communication session between a user and an automated communication service (e.g., a bot, etc.). The automated communication service may converse with the user using natural language communications. The automated communication service may identify requests from the user via the communication channel. The request may be a request to implement a task, a request to implement an event, a request for information, combinations thereof and/or the like. The automated communication service may be configured to invoke a machine-learning model (e.g., such as any of the aforementioned machine-learning models) to satisfy the request.

For example, a user may communicate with an automated communication service to request tickets to a particular soccer game. The automated communication service includes a classifier configured to identify particular types of requests within communications received from users. The particular types of requests include queries, requests for the computing device to perform an action, request for the computing device to generate an implementation of an event, request for the computing device to define tasks of an event, etc. The automated communication service determines an action to execute based on the types of requests. For instance, the automated communication service may facilitate execution of a machine-learning model of the computing device to generate an implementation of an event or task, establish a connection with a terminal device or admin user thereof, request additional information, retrieve requested information, etc.

At block 408, the computing device may execute the machine-learning model using the communications. For example, the automated communication service may identify a particular request within the communications of the communication session that may be resolved by the machine-learning model (e.g., such as request to generate an implementation of an event, etc.). For example, the particular request may be associated with a task that user intends to execute. The automated communication service may output instructions to the computing device to execute the machine-learning model. The instructions may include the communication, an identification of the particular request, combinations thereof, and/or the like. The computing device may define a feature vector from the communication, an identification of the particular request, combinations thereof, and/or the like. In some examples, the computing device may also use the family profile associated with the user to generate the feature vector. The family profile includes information associated with the user (e.g., an identification of the user, demographic information, family information, scheduling information, information associated previous communications from the user, information associated previous requests of the user, interests and/or preferences of the user, combinations thereof, and/or the like).

The machine-learning model may generate a probability that the machine-learning model can generate an implementation of the task (of the particular request). The machine-learning model may be configured to define implementations for various tasks and task types. The machine-learning model may determine if, based on the task type, particular request, and/or the communication whether the machine-learning model is capable of generating an implementation of the task. In some instances, the machine-learning model may define the probability based on the availability of processing resources, particular information that may be needed to generate the implementation of the task, a quantity of steps (sub tasks) associated with the task, etc. For example, the task may correspond to a request for tickets to a soccer game. The machine-learning model may use the task and user profile to determine what information is needed to execute the task (e.g., the particular soccer game the request corresponds to, the date and time of the game, the types of ticket to acquire, transportation to and from the soccer game, whether the user is available to attend the soccer game, etc.) and whether the machine-learning model has access to that information (e.g., website information, a calendar of the user, etc.). In some instances, tasks may be associated with a task template (e.g., a set of steps and/or information needed to execute the task, etc.). The task template may be defined by a user, an admit user, defined by the machine-learning model (e.g., based on previous successful operations of the computing device, etc.).

If the machine-learning model determines that the information needed is available and/or the computing device has the capability to implement the task or steps, then the machine-learning model may output at high probability. If the machine-learning model cannot determine what information is needed, if the information is unavailable, and/or if the computing device is unable to execute portions of the task or steps, then the machine-learning model may output a low probability. In some examples, the machine-learning model may weight particular types of information needed for generating the implementation of the task or implementing the task. The weights may be based on the degree in which any unavailable information can be obtained from additional sources (e.g., webpages, the user, an admin user, the data streams, etc.), a source of needed information being known, the user and/or the admin user being available, an interface to access information, an interface to implement a step or the task, combinations thereof, and/or the like. For example, information that is unavailable, but associated with a known source (e.g., such as an accessible database, the user via a request for the information from the automated communication service, etc.) may be weighted lower (e.g., have lower impact on the probability, etc.) than information that in unavailable with an unknown source (e.g., causing a higher impact to the probability due the machine-learning model being unable to determine how to access the missing information). A task that cannot be implemented by the machine-learning model or computing device may be weighted highest (e.g., having a largest impact on the probability).

The computing device may determine that the probability is less than a threshold. The threshold may be defined based on user input, admin user input, the computing device (e.g., based on historical operations of the computing device, etc.), and/or the like. A probability that is less than the threshold is an indication that the computing device cannot generate an implementation of the task and/or implement the task (e.g., because the task is too complex for the machine-learning model, there is insufficient information to generate the implementation of the task or implement task, any missing information needed to generate the implementation of the task or implement task is not accessible and/or known, the machine-learning model and/or the computing device is incapable of implementing the task or steps of the task, combinations thereof, and/or the like).

In response to determining that the probability is less than the threshold, the computing device connects a terminal device to the communication session. The terminal device is operated by agent (i.e., an admin user) configured to process the communication in place of the automated communication service. Some tasks and/or steps of tasks cannot be implemented (e.g., due to any of the aforementioned reasons, etc.). The computing device connects additional processing resources (e.g., the terminal device and admin user) to the communication session to facilitate implementation of the task to maintain processing of communications by the AI Agent Platform. For example, the task may be implemented using voice communications over a telephone that cannot be implemented by the automated communication service or computing device. In response, the computing device connects a terminal device and uses the admin user to implement the steps of the task, the task, and/or the like in place of the automated communication service. In some instances, the user is not notified that the terminal device is connected to create a seamless experience for the user (e.g., the user is unaware that the admin user implemented the task instead of the automated communication service and instead just detects the task being implemented). Once the task, steps of the task, and/or the like are implemented by the terminal device or admin user, the terminal device may be disconnected from the communication session and the communications may resume between the user and the automated communication service.

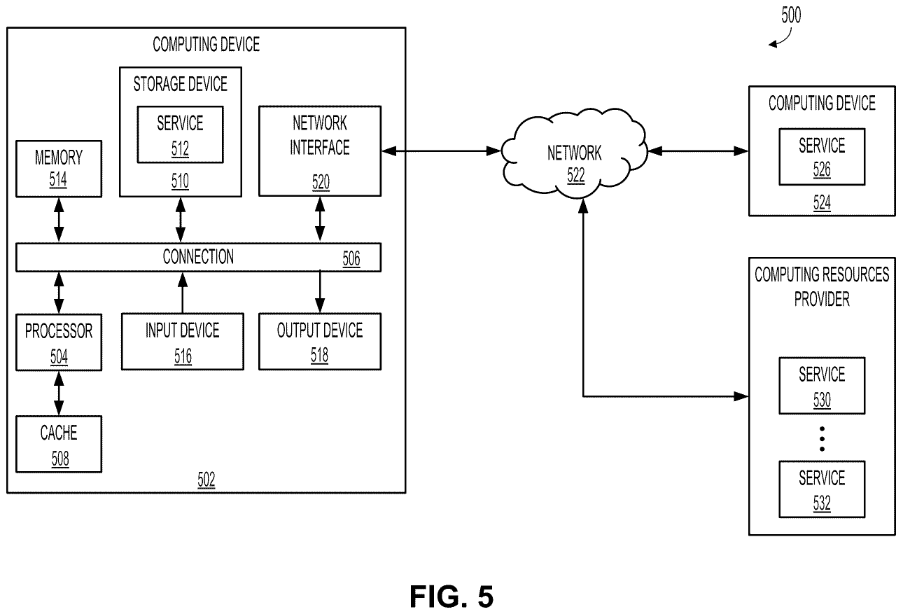

FIG. 5 illustrates an example computing device architecture of an example computing device that can implement the various techniques described herein according to aspects of the present disclosure. The example computing system 500 illustrated in FIG. 5 includes a computing device 502, which has various components in electrical communication with each other using a connection 506, such as a bus, in accordance with some implementations. The example computing system 500 includes a processor 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system 500 includes a cache 508 of high-speed memory connected directly with, in close proximity to, or integrated as part of the processor 504. The computing system 500 can copy data from the system memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The system memory 514 may be referred to herein as system memory or computer system memory. The system memory 514 may include, at various times, elements of an operating system, one or more applications, data associated with the operating system or the one or more applications, or other such data associated with the computing device 502.

Other system memory can be available for use as well. The memory can include multiple different types of memory with different performance characteristics. The processor 504 can include any general-purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system 500, the storage device 510 can be connected to other parts of the computing device 502 using the connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, system memory 514, input device 516, output device 518, and so forth, can carry out the functions such as those described herein.

The disclosed systems and services can be performed using a computing system such as the example computing system illustrated in FIG. 5, using one or more components of the example computing system 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 504 wherein the code is stored in memory such as system memory 514 as described herein. One or more of a user device, a provider server or system, a database system, or other such devices, services, or systems may include some or all of the components of the computing system such as the example computing system illustrated in FIG. 5, using one or more components of the example computing system 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The system memory 514 can be coupled to the processor 504 by, for example, a connector such as connection 506, or a bus. As used herein, a connector or bus such as connection 506 is a communications system that transfers data between components within the computing device 502 and may, in some embodiments, be used to transfer data between computing devices. The connection 506 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The system memory 514 can include random access memory (RAM) including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The system memory 514 can also include magnetic or optical data storage media including read-only (e.g., CD ROM and DVD ROM) or otherwise (e.g., CD or DVD). The memory can be local, remote, or distributed.

As described above, the connection 506 (or bus) can also couple the processor 504 to the storage device 510, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as system memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g., network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the one or more services 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving one or more real-time data streams associated with a family profile, wherein the family profile corresponds to one or more related users, and wherein the one or more real-time data streams are received from disparate sources; defining a dataset from the one or more real-time data streams by dynamic sampling of the real-time data stream according to a time window selected based on the family profile; detecting, based on the dataset, a correspondence between a portion of the dataset and an event of an event registry, wherein the event registry includes an identification of proactive events with a predicted significance for a user of the one or more related users; executing, in response to detecting the correspondence between the portion of the dataset and the event of the event registry, a machine-learning model using an identification of the event, the dataset, and the family profile, wherein the machine-learning model defines an implementation of the event for the user; receiving authorization to execute the event; and facilitating execution of the implementation of the event on behalf of the user.

Example 2 is the method of example(s) 1, further comprising: generating an event record corresponding to the event by: retrieving information from one or more external sources associated with the event; and receiving feedback from the user associated with the implementation of the event; and updating the family profile using the event record, wherein updating the family profile causes the machine-learning model to adjust future implementations of events from the event registry that improve metrics derived from the event record.

Example 3 is the method of example(s) 1, wherein the one or more data streams include sensor data from one or more wearable devices.

Example 4 is the method of example(s) 1, wherein the one or more data streams include data from an Internet-of-Things device.

Example 5 is the method of example(s) 1, wherein the one or more data streams include data received from a microphone or camera associated with the one or more related users.

Example 6 is the method of example(s) 1, wherein the one or more data streams include data periodically retrieved from one or more websites.

Example 7 is the method of example(s) 1, further comprising: defining a new dataset from the one or more real-time data streams; executing the machine-learning model using the new dataset, wherein the machine-learning model generates a probability that a new event will be accepted by the user; and modifying the event registry to include the new event based on the probability.

Example 8 is the method of example(s) 1, wherein defining the dataset from the one or more real-time data streams by dynamic sampling of the real-time data stream according to the time window selected based on the family profile includes: filtering the one or more data streams based on a timestamp associated with the data of the one or more data streams and a time constraint of the family profile; classifying, using a second machine-learning model, remaining data of the one or more data streams; and defining the dataset further by selecting portions of the remaining data based on classifying the remaining data.

Example 9 is a method comprising: receiving communications from a communication session between a user and an automated communication service, wherein the automated communication service is configured to converse with the user using natural language communications, and wherein the automated communication service invokes a machine-learning model to generate an implementation of task for execution on behalf of the user; executing the machine-learning model using the communications, wherein the machine-learning model generates a probability that the machine-learning model is configured to generate an implementation of a task identified in a communication of the communications; determining that the probability is less than a threshold; and connecting a terminal device to the communication session, wherein the terminal device is operated by agent configured to process the communication in place of the automated communication service.

Example 10 is the method of example(s) 9, further comprising: receiving new communications from the communication session, wherein the new communications include communications from the user and from the agent; modifying a configuration of the automated communication service using the new communications; and retraining the automated communication service using the configuration, wherein the retraining the automated communication service enables the automated communication service to classify tasks within communications and determine whether an implementation of the tasks can be generated by the machine-learning model.

Example 11 is the method of example(s) 9, further comprising: receiving new communications from the communication session, wherein the new communications include communications from the user and from the agent; executing the machine-learning model using the new communications to classify an intent associated with the communications; and reconnecting the automated communication service to the communication session in response to an intent associated with a new communication of the new communications.

Example 12 is the method of example(s) 9, further comprising: receiving new communications from the communication session, wherein the new communications include communications from the user and from the agent; and disconnecting the agent from the communication session based on the new communications.

Example 13 is the method of example(s) 9, wherein the machine-learning model generates the probability based on an assigned complexity of the task.

Example 14 is the method of example(s) 9, wherein the machine-learning model generates the probability based on a predicted emotional state of the user.

Example 15 is the method of example(s) 9, wherein the machine-learning model generates the probability based on a classification of the task.

Example 16 is a system comprising: one or more processors; a non-transitory computer-readable medium storing instructions that when executed by the one or more processors, cause the one or more processors to perform the methods of any of example(s)s 1-15.

Example 17 is a non-transitory computer-readable medium storing instructions that when executed by one or more processors, cause the one or more processors to perform the methods of any of example(s)s 1-15.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving a real-time data stream associated with a profile, wherein the profile corresponds to one or more related users;
defining a dataset from the real-time data stream by dynamic sampling the real-time data stream according to a time window selected based on the profile;
detecting, based on the dataset, a correspondence between a portion of the dataset and an event of an event registry, wherein the event registry includes an identification of proactive events with a predicted significance for a user of the one or more related users;
executing, in response to detecting the correspondence between the portion of the dataset and the event of the event registry, a machine-learning model using an identification of the event, the dataset, and the profile, wherein the machine-learning model defines an implementation of the event for the user;
receiving authorization to execute the event; and
facilitating execution of the implementation of the event on behalf of the user.

2. The method of claim 1, further comprising:
generating an event record corresponding to the event by:
retrieving information from one or more external sources associated with the event; and
receiving feedback from the user associated with the implementation of the event; and
updating the profile using the event record, wherein updating the profile causes the machine-learning model to adjust future implementations of events from the event registry that improve metrics derived from the event record.

3. The method of claim 1, wherein the real-time data stream includes sensor data from one or more wearable devices.

4. The method of claim 1, wherein the real-time data stream includes data from an Internet-of-Things device.

5. The method of claim 1, wherein the real-time data stream includes data received from a microphone or camera associated with the one or more related users.

6. The method of claim 1, wherein the real-time data stream includes data periodically retrieved from one or more websites.

7. The method of claim 1, further comprising:
defining a new dataset from the real-time data stream;
executing the machine-learning model using the new dataset, wherein the machine-learning model generates a probability that a new event will be accepted by the user; and
modifying the event registry to include the new event based on the probability.

8. A system comprising:
one or more processors; and
a non-transitory computer-readable medium storing instructions that when executed by the one or more processors, cause the one or more processors to perform operations including:
receiving a real-time data stream associated with a profile, wherein the profile corresponds to one or more related users;
defining a dataset from the real-time data stream by dynamic sampling the real-time data stream according to a time window selected based on the profile;
detecting, based on the dataset, a correspondence between a portion of the dataset and an event of an event registry, wherein the event registry includes an identification of proactive events with a predicted significance for a user of the one or more related users;
executing, in response to detecting the correspondence between the portion of the dataset and the event of the event registry, a machine-learning model using an identification of the event, the dataset, and the profile, wherein the machine-learning model defines an implementation of the event for the user;
receiving authorization to execute the event; and
facilitating execution of the implementation of the event on behalf of the user.

9. The system of claim 8, wherein the operations further include:
generating an event record corresponding to the event by:
retrieving information from one or more external sources associated with the event; and
receiving feedback from the user associated with the implementation of the event; and
updating the profile using the event record, wherein updating the profile causes the machine-learning model to adjust future implementations of events from the event registry that improve metrics derived from the event record.

10. The system of claim 8, wherein the real-time data stream includes sensor data from one or more wearable devices.

11. The system of claim 8, wherein the real-time data stream includes data from an Internet-of-Things device.

12. The system of claim 8, wherein the real-time data stream includes data received from a microphone or camera associated with the one or more related users.

13. The system of claim 8, wherein the real-time data stream includes data periodically retrieved from one or more websites.

14. The system of claim 8, wherein the operations further include:
defining a new dataset from the real-time data stream;
executing the machine-learning model using the new dataset, wherein the machine-learning model generates a probability that a new event will be accepted by the user; and
modifying the event registry to include the new event based on the probability.

15. A non-transitory computer-readable medium storing instructions that when executed by one or more processors, cause the one or more processors to perform operations including:
receiving a real-time data stream associated with a profile, wherein the profile corresponds to one or more related users;
defining a dataset from the real-time data stream by dynamic sampling the real-time data stream according to a time window selected based on the profile;
detecting, based on the dataset, a correspondence between a portion of the dataset and an event of an event registry, wherein the event registry includes an identification of proactive events with a predicted significance for a user of the one or more related users;
executing, in response to detecting the correspondence between the portion of the dataset and the event of the event registry, a machine-learning model using an identification of the event, the dataset, and the profile, wherein the machine-learning model defines an implementation of the event for the user;
receiving authorization to execute the event; and
facilitating execution of the implementation of the event on behalf of the user.

16. The non-transitory computer-readable medium of claim 15, wherein the operations further include:
generating an event record corresponding to the event by:
retrieving information from one or more external sources associated with the event; and
receiving feedback from the user associated with the implementation of the event; and
updating the profile using the event record, wherein updating the profile causes the machine-learning model to adjust future implementations of events from the event registry that improve metrics derived from the event record.

17. The non-transitory computer-readable medium of claim 15, wherein the real-time data stream includes include sensor data from one or more wearable devices.

18. The non-transitory computer-readable medium of claim 15, wherein the real-time data stream includes include data from an Internet-of-Things device.

19. The non-transitory computer-readable medium of claim 15, wherein the real-time data stream includes include data received from a microphone or camera associated with the one or more related users.

20. The non-transitory computer-readable medium of claim 15, wherein the real-time data stream includes data periodically retrieved from one or more websites.
